(19) United States
(12) Patent Application Publication
(10) Pub. No.: US 2022/0297000 A1
(43) Pub. Date: Sep. 22, 2022

(54) METHOD FOR PROCESSING GAME LIVE STREAMING AND ELECTRONIC DEVICE

(71) Applicant: BEIJING DAJIA INTERNET INFORMATION TECHNOLOGY CO., LTD., Beijing (CN)

(72) Inventor: Xiao Tang, Beijing (CN)

(21) Appl. No.: 17/837,383

(22) Filed: Jun. 10, 2022

Related U.S. Application Data
(63) Continuation of application No. PCT/CN2021/105533, filed on Jul. 9, 2021.

(30) Foreign Application Priority Data
Dec. 7, 2020 (CN) 202011413412.X

(51) Int. Cl. A63F 13/355; A63F 13/73; A63F 13/86; H04N 21/2187; H04N 21/478

(52) U.S. Cl. CPC A63F 13/355; A63F 13/73; A63F 13/86; H04N 21/2187; H04N 21/4781; A63F 2300/538

(57) ABSTRACT

Provided a method for processing game live streaming, including: acquiring, in response to a first request from an audience terminal, a first video stream from the audience terminal, wherein the first request is configured to request an anchor terminal to perform online game teaching on a current live-streaming game; and pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

### CROSS-REFERENCE TO RELATED APPLICATION

This application is a continuation application of International Application No. PCT/CN2021/105533, filed on Jul. 9, 2021 which claims the benefit of priority to Chinese Application No. 202011413412.X, filed on Dec. 7, 2020, both of which are incorporated by reference herein.

### TECHNICAL FIELD

The present disclosure relates to the field of gaming technologies, and in particular, relates to a method for processing game live streaming and an electronic device.

### BACKGROUND

In the related art, game live-streaming generally refers to a method in which an audience learns how to play a game by watching an anchor playing the game. In the case that the audience wants to practice playing the game, the audience needs to practice alone after the live-streaming, and an audience client cannot interact with an anchor client in the game live-streaming process.

### SUMMARY

The present disclosure provides a method for processing game live streaming and an electronic device. The technical solutions of the present disclosure are as follows.

According to an aspect of embodiments of the present disclosure, a method for processing game live streaming is provided. The method includes:

acquiring, in response to a first request from an audience terminal, a first video stream from the audience terminal, wherein the first request is configured to request an anchor terminal to perform online game teaching on a current live-streaming game; and

pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

According to another aspect of embodiments of the present disclosure, an electronic device is provided. The electronic device includes: a processor; and a memory configured to store one or more instructions executable by the processor, when loading and executing the one or more instructions, is caused to perform:

acquiring, in response to a first request from an audience terminal, a first video stream from the audience terminal, wherein the first request is configured to request an anchor terminal to perform online game teaching on a current live-streaming game; and

pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

According to another aspect of embodiments of the present disclosure, a non-transitory storage medium is provided. The non-transitory storage medium stores one or more instructions therein, wherein the one or more instructions, when loaded and executed by a processor of an electronic device, cause the electronic device to perform:

acquiring, in response to a first request from an audience terminal, a first video stream from the audience terminal, wherein the first request is configured to request an anchor terminal to perform online game teaching on a current live-streaming game; and

pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

### BRIEF DESCRIPTION OF THE DRAWINGS

FIG. 1 is a schematic diagram of a scenario of a method for processing game live streaming according to some embodiments of the present disclosure;

FIG. 2 is a flowchart of a method for processing game live streaming according to some embodiments of the present disclosure;

FIG. 3 is a flowchart of another method for processing game live streaming according to some embodiments of the present disclosure;

FIG. 4 is a flowchart of another method for processing game live streaming according to some embodiments of the present disclosure;

FIG. 5 is a flowchart of another method for processing game live streaming according to some embodiments of the present disclosure;

FIG. 6 is a flowchart of another method for processing game live streaming according to some embodiments of the present disclosure;

FIG. 7 is a block diagram of an apparatus for processing game live-streaming according to some embodiments of the present disclosure; and

FIG. 8 is a block diagram of an electronic device according to some embodiments of the present disclosure.

### DETAILED DESCRIPTION

To make those of ordinary skill in the art better understand the technical solutions of the present disclosure, the following clearly and completely describes the technical solutions in embodiments of the present disclosure with reference to the accompanying drawings.

The phrase “at least one of A, B, and C” includes the following cases: A alone, B alone, C alone, A and B, A and C, B and C, and A, B, and C.

FIG. 1 is a schematic diagram of a scenario of a method for processing game live streaming according to some embodiments. As shown in FIG. 1, the scenario includes: a live-streaming server 101, a cloud game server 102, an anchor terminal 103, and an audience terminal 104.

In some embodiments, the live-streaming server 101 is responsible for receiving a game video stream from the cloud game server 102, and pushing the game video stream to the anchor terminal 103 and the audience terminal 104. In response to an anchor having the game control permission, the anchor terminal 103 is responsible for sending a game operation instruction of an anchor to the live-streaming server 101, and then the live-streaming server 101 sends a game operation instruction to the cloud game server 102. In addition, the anchor terminal 103 also supports pushing a local video stream, and in response to the local video stream pushed by the anchor terminal 103, the live-streaming server 101 switches from the game video stream to the local video stream pushed by the anchor terminal 103. In addition, in response to the audience terminal 104 controlling the current live-streaming game, that is, the audience having the game control permission, the audience terminal 104 is responsible for sending a game operation instruction of the audience to the live-streaming server 101.

In some embodiments, the method for processing game live streaming is applied to an online paid teaching scene of cloud game live-streaming. An audience A applies for game teaching, and control authority of a current live-streaming game is switched to audience A after an anchor agrees. The anchor teaches the audience A while watching operations of the audience A. Moreover, in the teaching process, it is supported to switch the control authority of the current live-streaming game from the audience A to the anchor, such that the anchor can explain while demonstrating the process to the audience. At the same time, other audiences in a live-streaming room can also watch the whole game teaching process.

In some other embodiments, the type of the anchor terminal 103 or the audience terminal 104 includes, but is not limited to smart phone, tablet computer, notebook computer, e-reader, a desktop computer, and the like.

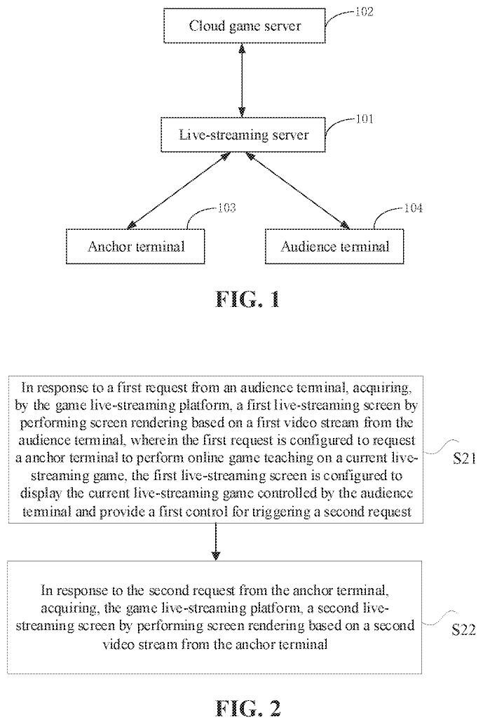

FIG. 2 is a flowchart of a method for processing game live streaming according to some embodiments. As shown in FIG. 2, the method for processing game live streaming is applied to a game live-streaming platform. For example, the game live-streaming platform is the live-streaming server 101 in FIG. 1, and the method includes the following steps S21 to S22.

In S21, in response to a first request from an audience terminal, the game live-streaming platform acquires a first live-streaming screen by performing screen rendering based on a first video stream from the audience terminal, wherein the first request is configured to request an anchor terminal to perform online game teaching on a current live-streaming game, the first live-streaming screen is configured to display the current live-streaming game controlled by the audience terminal and provide a first control for triggering a second request.

The first video stream is also referred to as a first game video stream, and the first live-streaming screen is also referred to as a first game live-streaming screen. After receiving the first request from the audience terminal, the game live-streaming platform acquires the first live-streaming screen by performing screen rendering based on the first video stream from the audience terminal. In this case, the anchor terminal and other audience terminals in a live-streaming room all display the first live-streaming screen. The screen rendering means that a video stream is converted into a visual screen.

In some embodiments, the first request is configured to request the anchor terminal to perform online game teaching on the current live-streaming game. The online game teaching involves a switch of the control authority of the current live-streaming game. Initially, the control authority of the current live-streaming game belongs to the anchor terminal. The first request is used by the audience terminal for requesting to acquire the control authority of the current live-streaming game; the second request is used by the anchor terminal for requesting to switch the control authority of the current live-streaming game, that is, requesting to switch the control authority of the current live-streaming game from the audience terminal to the anchor terminal, and the second request is essentially configured to request the control authority of the current live-streaming game.

In S22, in response to the second request from the anchor terminal, the game live-streaming platform acquires a second live-streaming screen by performing screen rendering based on a second video stream from the anchor terminal.

The second video stream is also referred to as a second game video stream, and the second live-streaming screen is also referred to as a second game live-streaming screen. After receiving the second request from the anchor terminal, the game live-streaming platform acquires the second live-streaming screen by switching the live-streaming screen, and performing screen rendering based on the second game video stream from the anchor terminal. In this case, the audience terminal and other audience terminals in the live-streaming room all display the second live-streaming screen. That is, the game live-streaming platform switches the first video stream to the second video stream, such that the first live-streaming screen is switched to the second live-streaming screen.

The embodiments of the present disclosure allow an audience terminal and an anchor terminal to interact with each other for a current live-streaming game in a game live-streaming process, which can improve the interactivity between an anchor and an audience.

In some embodiments, a live-streaming screen including a cloud game scene is rendered in the game live-streaming platform, wherein the cloud game scene is a scene in which the audience terminal and the anchor terminal interact with each other based on the current live-streaming game in the live-streaming screen. The cloud game scene includes at least one of audio data of the current live-streaming game, microphone audio data of the audience terminal, and microphone audio data of the anchor terminal. For example, the first live-streaming screen includes an audio part, and the audio part includes at least one of audio data of the current live-streaming game, microphone audio data of the audience terminal, or microphone audio data of the anchor terminal.

In some embodiments, in the process that the anchor provides an online game teaching service for the audience A, the control authority of the current live-streaming game is owned by the audience A, and the game live-streaming platform receives the first video stream from the audience terminal, and pushes the first video stream to the anchor terminal, such that the current live-streaming game controlled by the audience terminal is displayed and the second control for triggering the second request is provided in the audience terminal and the anchor terminal.

In some embodiments, the anchor and the audience A can apply for switching the control authority of the current live-streaming game at any time in the process of online game teaching. For example, the anchor triggers the second request by clicking the first control (e.g., in the form of a button) provided by the first live-streaming screen on the anchor terminal, to request the control authority of the current live-streaming game, and the first video is switched to the second video stream from the anchor terminal by the game live-streaming platform; that is, the anchor could narrate to the audience A while demonstrate the game.

Moreover, all other audiences in the live-streaming room beside the audience A could also watch and hear the teaching process.

The embodiments of the present disclosure can significantly improve the interactivity between the anchor and the audience and help the audience learn game skills conveniently. By using the characteristics of the cloud game scene, while teaching the audience to play the game, the anchor can acquire the control authority of the current live-streaming game at any time; related game skills are displayed in the current live-streaming room, as if the anchor and the audience are in a face-to-face teaching scene.

FIG. 3 is a flowchart of another method for processing game live streaming according to some embodiments. As shown in FIG. 3, the method for processing game live streaming is applied to a game live-streaming platform. For example, the game live-streaming platform is the live-streaming server 101 in FIG. 1, and the method includes the following steps S31 to S32.

In S31, in response to a first request from an audience terminal, a first video stream from the audience terminal is acquired, wherein the first request is configured to request an anchor terminal to perform online game teaching on a current live-streaming game.

In some embodiments, the game live-streaming platform switches, in response to the first request, a control authority of the current live-streaming game from the anchor terminal to the audience terminal.

In S32, the first video stream is pushed to the anchor terminal, such that the anchor terminal acquires a first live-streaming screen by performing screen rendering based on the first video stream, wherein the first live-streaming screen is configured to display the current live-streaming game controlled by the audience terminal.

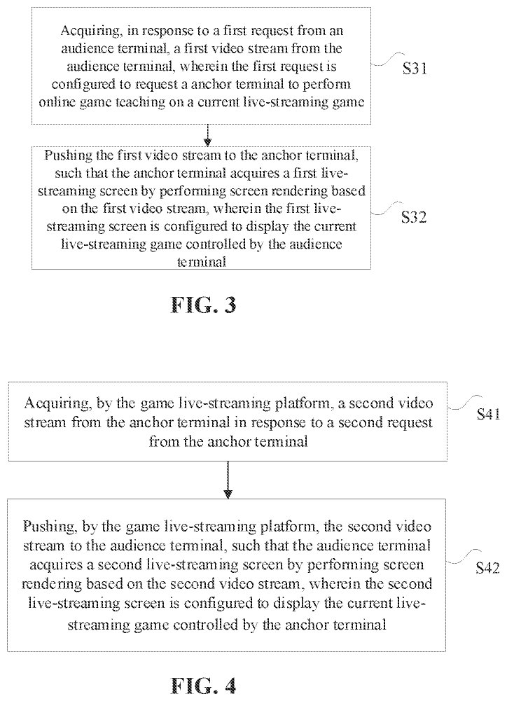

In some embodiments, referring to FIG. 4, the method for processing game live streaming further includes the following steps S41 to S42.

In S41, the game live-streaming platform acquires a second video stream from the anchor terminal in response to a second request from the anchor terminal.

Step S41 and step S42 are performed before step S31, for the current live-streaming game, before the audience applies for online game teaching, the control authority of the current live-streaming game is owned by the anchor terminal, and the audience accesses the live-streaming room to watch the anchor on the anchor terminal play the game; correspondingly, the audience terminal in the live-streaming room displays the current live-streaming game controlled by the anchor terminal.

In S42, the game live-streaming platform pushes the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the game live-streaming platform switches, in response to receiving the second request, a control authority of the current live-streaming game from the audience terminal to the anchor terminal. In some embodiments, a first control for triggering the second request is provided by the first live-streaming screen, and a second control for triggering the first request is provided by the second live-streaming screen.

The first control is displayed on the first live-streaming screen, and the second control is displayed on the second live-streaming screen. The first control is configured to switch the control authority of the current live-streaming game from the audience terminal to the anchor terminal, and the second control is configured to switch the control authority of the current live-streaming game from the anchor terminal to the audience terminal. The two controls can allow the control authority of the current live-streaming game to be switched between the anchor terminal and the audience terminal flexibly, which brings great convenience to the online game teaching and achieves high interaction efficiency.

In the embodiments of the present disclosure, the audience terminal and the anchor terminal are in the same live-streaming room. The live-streaming room is used for performing game live streaming and is managed by the game live-streaming platform. The anchor terminal performs a game live streaming in the live-streaming room and controls the current live-streaming game, such that a second video stream is generated. The anchor terminal sends the second video stream to the game live-streaming platform, and the game live-streaming platform pushes the second video stream to the audience terminal in the live-streaming room, such that the audience terminal displays a second live-streaming screen acquired by performing screen rendering based on the second video stream, and the audience of the audience terminal can watch the process in which the anchor of the anchor terminal controls the game.

The audience terminal can send a first request to the game live-streaming platform, wherein the first request is configured to request the anchor terminal to perform online game teaching on a current live-streaming game. The game live-streaming platform sends the first request to the anchor terminal, and after the anchor terminal confirms the first request, the game live-streaming platform switches the control authority of the current live-streaming game from the anchor terminal to the audience terminal, such that the audience terminal controls the current live-streaming game, generates the first video stream, and sends the first video stream to the game live-streaming platform. The game live-streaming platform pushes the first video stream to the anchor terminal and other audience terminals in the live-streaming room, such that the anchor terminal and other audience terminals display the first live-streaming screen which are acquired by performing screen rendering based on the first video stream, and the anchor of the anchor terminal and audiences of other audience terminals can watch the process in which the audience of the audience terminal controls the game.

In addition, in the case that the audience terminal controls the current live-streaming game, the anchor terminal can also send local video stream or local audio stream to the game live-streaming platform, for example, the local video stream is acquired by an image acquiring assembly on the anchor terminal and the local audio stream is acquired by an audio acquiring assembly on the anchor terminal. The game live-streaming platform can also push the local video stream or local audio stream from the anchor terminal to the audience terminal (such as the audience terminal) in the live-streaming room, such that the audience in the live-streaming room can watch the screen of the anchor of the anchor terminal or hear the voice of the anchor. Therefore, the anchor of the anchor terminal can teach and guide the process of operating/playing the game by an audience of the audience terminal online.

In addition, in the process of controlling the current live-streaming game by the audience terminal, the anchor terminal can send a second request to the game live-streaming platform at any time, wherein the second request is configured to request to switch the control authority of the current live-streaming game from audience terminal to the anchor terminal. The game live-streaming platform switches, in response to the second request from the anchor terminal, the control authority of the current live-streaming game from the audience terminal to the anchor terminal. The anchor terminal controls the current live-streaming game again, generates the second video stream, and sends the second video stream to the game live-streaming platform.

In the embodiments of the present disclosure, in the process of performing game live streaming, the control authority of the current live-streaming game can be switched between the anchor terminal and the audience terminal, such that the process of the anchor terminal controlling the game or the process of the audience terminal controlling the game is realized, which improves the flexibility of the game lives streaming process, and expands a new type of game live-streaming function.

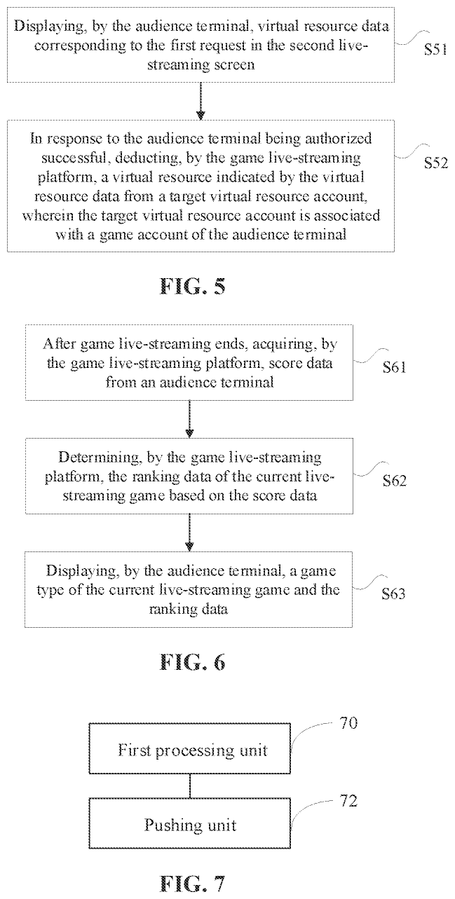

In some embodiments, referring to FIG. 5, before acquiring the first game video stream from the audience terminal, the method for processing game live streaming further includes the following steps S51 to S52.

In S51, the audience terminal displays virtual resource data corresponding to a first request in a second live-streaming screen.

In some embodiments, in the case that a payment guiding teaching function is used by the anchor, the second live-streaming screen is further configured to display the virtual resource data corresponding to the first request. For example, the audience A logs into the audience terminal to access the live-streaming room, and watches the cloud game live-streaming of the anchor terminal in the live-streaming room normally. Because the current live-streaming game in the live-streaming room is controlled by the anchor terminal, the anchor terminal can enable the payment guiding teaching function at any time, and set a corresponding payment amount, for example, 10 yuan per round. After the anchor terminal finishes the settings, the audience terminal displays a window for applying for payment guiding and the corresponding payment amount.

In some embodiments, the window for applying for payment guiding corresponds to the second control (for example, a button control) provided by the second live-streaming screen, and the corresponding payment amount is the virtual resource data corresponding to the first request.

The audience A triggers the first request by clicking the second control displayed on the audience terminal to apply for payment, and then the anchor teaches the audience A to practice the current live-streaming game. After the anchor receives and approves the application for payment guiding from the audience A, a payment window pops up in the audience terminal, and the virtual resource data corresponding to the first request is displayed. In some embodiments, the payment window is placed in front, and is displayed in front of the second live-streaming screen.

In S52, in response to an authorization success message from the audience terminal, the game live-streaming platform deducts a virtual resource indicated by the virtual resource data from a target virtual resource account, wherein the target virtual resource account is associated with an account of the audience terminal.

The account of the audience terminal may be a game account of the audience terminal, an account of the audience terminal in a live-streaming room, or the like. The target virtual resource account is configured to store virtual resources. For example, the virtual resource is virtual currency or an electronic ticket circulating in the game live-streaming platform and the like.

In response to the audience terminal being authorized successful, that is, in response to an authorization success message from the audience terminal, the game live-streaming platform acquires a payment amount from the target virtual resource account corresponding to the audience terminal, and switches the control authority of the current live-streaming game to the audience terminal after the audience terminal makes a payment successfully, wherein the authorization success message indicates that the audience terminal is authorized to transfer the virtual resource; in this case, the anchor and the audience A are in a voice microphone connection, and the anchor teaches the audience A based on the current live-streaming game.

In some embodiments, FIG. 6 is a flowchart of another method for processing game live streaming according to some embodiments. Referring to FIG. 6, the method for processing game live streaming further includes the following steps S61 to S63.

In S61, after game live-streaming ends, the game live-streaming platform acquires score data from an audience terminal.

In some embodiments, in response to completing the online game teaching, the game live-streaming platform switches the control authority of the current live-streaming game from the audience terminal to the anchor terminal, and receives and stores the score data from the audience terminal, wherein the score data is configured to evaluate the online game teaching of the anchor terminal.

In S62, the game live-streaming platform determines ranking data of the current live-streaming game based on the score data.

After the online game guiding ends, the control authority of the current live-streaming game is switched to the anchor terminal, the audience A scores the game guiding process; the game live-streaming platform acquires and records score data from different audience terminals, and determines ranking data of the current live-streaming game based on the score data of the current live-streaming game, wherein the ranking data records score rankings of different anchors providing online game teaching for the live-streaming game, and the ranking data of the current live-streaming game indicates score rankings of anchors providing online game teaching for the current live-streaming game.

In some embodiments, after determining the ranking data of the current live-streaming game, the game live-streaming platform sends the ranking data of the current live-streaming game to the audience terminal. Besides, the game live-streaming platform can also send the ranking data to any terminal (such as audience terminal or anchor terminal) in the live-streaming room.

In S63, the audience terminal displays a game type of the current live-streaming game and the ranking data.

In some embodiments, the embodiments of the present disclosure support displaying the game type of the current live-streaming game and the ranking data. For example, according to live-streaming games of different types, score rankings of corresponding anchors are displayed. In response to the audience needing online game guidance, an anchor with the highest score can be selected according to the rankings to guide the audience to play the online game.

Each embodiment of the present disclosure can be executed alone, or executed together with other embodiments, which are all considered as the protection scope of the present disclosure.

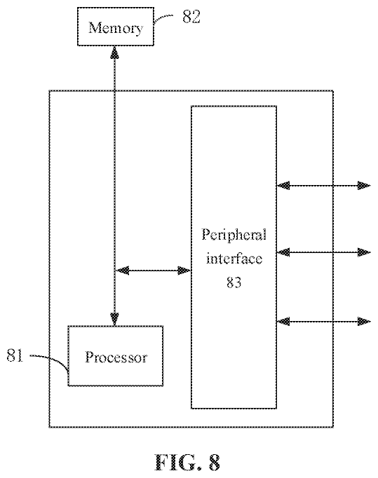

FIG. 7 is a block diagram of an apparatus for processing game live-streaming according to some embodiments. As shown in FIG. 7, the apparatus includes: a first processing unit 70 and a pushing unit 72.

The first processing unit 70 is configured to acquire, in response to a first request from an audience terminal, a first video stream from the audience terminal, wherein the first request is configured to request an anchor terminal to perform online game teaching on a current live-streaming game.

The pushing unit 72 is configured to push the first video stream to the anchor terminal, such that the anchor terminal acquires a first live-streaming screen by performing screen rendering based on the first video stream, wherein the first live-streaming screen is configured to display the current live-streaming game controlled by the audience terminal.

It should be noted that the first processing unit 70 and the pushing unit 72 correspond to step S31 to step S32 in the above method embodiment. The modules are the same as the examples and application scenes realized by the corresponding steps, but are not limited to the content disclosed in the embodiment of the method for processing game live streaming. It should be noted that the above modules may be operated in an electronic device as a part of the apparatus.

In some embodiments, the apparatus for processing game live-streaming is further configured to perform:

switching, in response to the first request, a control authority of the current live-streaming game from the anchor terminal to the audience terminal.

In some embodiments, the apparatus for processing game live-streaming further includes:

a second processing unit, configured to acquire, in response to a second request from the anchor terminal, a second video stream from the anchor terminal; and

the pushing unit, further configured to push the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the apparatus for processing game live-streaming is further configured to perform:

switching, in response to receiving the second request, the control authority of the current live-streaming game from the audience terminal to the anchor terminal.

In some embodiments, the first live-streaming screen includes an audio part, and the audio part includes at least one of audio data of the current live-streaming game, microphone audio data of the audience terminal, or microphone audio data of the anchor terminal.

In some embodiments, the second live-streaming screen is further configured to display virtual resource data corresponding to the first request; and the apparatus for processing game live-streaming further includes:

a first acquiring unit, configured to deduct, in response to an authorization success message from the audience terminal, a virtual resource indicated by the virtual resource data from a target virtual resource account, wherein the target virtual resource account is associated with an account of the audience terminal;

wherein the authorization success message indicates that the audience terminal is authorized to transfer the virtual resource.

In some embodiments, the apparatus for processing game live-streaming further includes:

a second acquiring unit, configured to switch, in response to completing the online game teaching, a control authority of the current live-streaming game from the audience terminal to the anchor terminal.

In some embodiments, the apparatus for processing game live-streaming further includes:

a second acquiring unit, configured to receive and store score data from the audience terminal, wherein the score data is configured to evaluate the online game teaching of the anchor terminal.

In some embodiments, the apparatus for processing game live-streaming further includes:

a determining unit, configured to determine ranking data of the current live-streaming game based on the score data of the current live-streaming game, wherein the ranking data indicates score rankings of anchors providing online game teaching for the current live-streaming game;

the determining unit, further configured to send the ranking data of the current live-streaming game to the audience terminal, wherein the audience terminal is configured to display the ranking data of the current live-streaming game and a game type of the current live-streaming game.

For the apparatus in the above embodiment, specific manner in which each module operates has been described in detail in the embodiments related to the method, and will not be described in detail here.

According to the embodiments of the present disclosure, an electronic device is further provided. The electronic device includes: a processor; and a memory configured to store one or more instructions executable by the processor, wherein the processor, when loading and executing the one or more instructions, is caused to perform:

acquiring, in response to a first request from an audience terminal, a first video stream from the audience terminal, wherein the first request is configured to request an anchor terminal to perform online game teaching on a current live-streaming game; and

pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

In some embodiments, the processor is further caused to perform:

switching, in response to the first request, a control authority of the current live-streaming game from the anchor terminal to the audience terminal.

In some embodiments, the processor is further caused to perform:

acquiring, in response to a second request from the anchor terminal, a second video stream from the anchor terminal; and

pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the processor is further caused to perform:

switching, in response to receiving the second request, a control authority of the current live-streaming game from the audience terminal to the anchor terminal.

In some embodiments, the first live-streaming screen includes an audio part, and the audio part includes at least one of audio data of the current live-streaming game, microphone audio data of the audience terminal, or microphone audio data of the anchor terminal.

In some embodiments, the second live-streaming screen is further configured to display virtual resource data corresponding to the first request; and the processor is further caused to perform:

deducting, in response to an authorization success message from the audience terminal, a virtual resource indicated by the virtual resource data from a target virtual resource account, wherein the target virtual resource account is associated with an account of the audience terminal;

wherein the authorization success message indicates that the audience terminal is authorized to transfer the virtual resource.

In some embodiments, the processor is further caused to perform:

switching, in response to completing the online game teaching, a control authority of the current live-streaming game from the audience terminal to the anchor terminal.

In some embodiments, the processor is further caused to perform:

receiving and storing score data from the audience terminal, wherein the score data is configured to evaluate the online game teaching of the anchor terminal.

In some embodiments, the processor is further caused to perform:

determining ranking data of the current live-streaming game based on the score data of the current live-streaming game, wherein the ranking data indicates score rankings of anchors providing online game teaching for the current live-streaming game;

sending the ranking data of the current live-streaming game to the audience terminal, wherein the audience terminal is configured to display the ranking data of the current live-streaming game and a game type of the current live-streaming game.

In some embodiments, FIG. 8 is a block diagram of an electronic device according to some embodiments. As shown in FIG. 8, the electronic device includes: at least one (only one is shown in the figure) processor 81, a memory 82, and a peripheral interface 83.

The memory 82 is configured to store computer programs and modules, such as instructions corresponding to the method for processing game live streaming in the embodiments of the present disclosure and the modules corresponding to the apparatus for processing game live streaming. The processor 81 runs the software programs and modules stored in the memory 82, thereby executing various functional applications and data processing, to perform the above method for processing game live streaming.

In some embodiments, the memory 82 includes a high-speed random access memory and a non-transitory memory, such as one or more magnetic storage apparatuses, flash memories, or other non-transitory solid-state memories. In some embodiments, the memory 82 further includes memories remotely configured relative to the processor 81, and these remote memories may be connected to the electronic device through a network. Examples of the foregoing network include, but are not limited to, the Internet, an enterprise intranet, a local area network, a mobile communication network, and a combination thereof.

In some embodiments, the processor 81 calls information and application programs stored in the memory 82, to perform the above method for processing game live streaming. For example, the transmission apparatus is a memory controller.

In some embodiments, the peripheral interface 83 is configured to connect to a radio frequency module, an audio module, a display screen, and the like.

According to the embodiments of the present disclosure, a non-transitory storage medium is further provided. The non-transitory storage medium stores one or more instructions therein, wherein the one or more instructions, when loaded and executed by a processor of an electronic device, cause the electronic device to perform:

acquiring, in response to a first request from an audience terminal, a first video stream from the audience terminal, wherein the first request is configured to request an anchor terminal to perform online game teaching on a current live-streaming game; and

pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the one or more instructions further cause the electronic device to perform:

switching, in response to the first request, a control authority of the current live-streaming game from the anchor terminal to the audience terminal.

In some embodiments, the one or more instructions further cause the electronic device to perform:

acquiring, in response to a second request from the anchor terminal, a second video stream from the anchor terminal; and

pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the one or more instructions further cause the electronic device to perform:

switching, in response to receiving the second request, a control authority of the current live-streaming game from the audience terminal to the anchor terminal.

In some embodiments, the first live-streaming screen includes an audio part, and the audio part includes at least one of audio data of the current live-streaming game, microphone audio data of the audience terminal, or microphone audio data of the anchor terminal.

In some embodiments, the second live-streaming screen is further configured to display virtual resource data corresponding to the first request; and the one or more instructions further cause the electronic device to perform:

deducting, in response to an authorization success message from the audience terminal, a virtual resource indicated by the virtual resource data from a target virtual resource account, wherein the target virtual resource account is associated with an account of the audience terminal;

wherein the authorization success message indicates that the audience terminal is authorized to transfer the virtual resource.

In some embodiments, the one or more instructions further cause the electronic device to perform:

switching, in response to completing the online game teaching, a control authority of the current live-streaming game from the audience terminal to the anchor terminal.

In some embodiments, the one or more instructions further cause the electronic device to perform:

receiving and storing data from the audience terminal, wherein the score data is configured to evaluate the online game teaching of the anchor terminal.

In some embodiments, the one or more instructions further cause the electronic device to perform:

determining ranking data of the current live-streaming game based on the score data of the current live-streaming game, wherein the ranking data indicates score rankings of anchors providing online game teaching for the current live-streaming game;

sending the ranking data of the current live-streaming game to the audience terminal, wherein the audience terminal is configured to display the ranking data of the current live-streaming game and a game type of the current live-streaming game.

According to the embodiments of the present disclosure, a computer program product is provided. The computer program product stores one or more instructions therein, wherein the one or more instructions, when loaded and executed by a processor of an electronic device, cause the electronic device to perform:

acquiring, in response to a first request from an audience terminal, a first video stream from the audience terminal, wherein the first request is configured to request an anchor terminal to perform online game teaching on a current live-streaming game; and

pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

In some embodiments, the one or more instructions further cause the electronic device to perform:

switching, in response to the first request, a control authority of the current live-streaming game from the anchor terminal to the audience terminal.

In some embodiments, the one or more instructions further cause the electronic device to perform:

acquiring, in response to a second request from the anchor terminal, a second video stream from the anchor terminal; and

pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

In some embodiments, the one or more instructions further cause the electronic device to perform:

switching, in response to receiving the second request, a control authority of the current live-streaming game from the audience terminal to the anchor terminal.

In some embodiments, the first live-streaming screen includes an audio part, and the audio part includes at least one of audio data of the current live-streaming game, microphone audio data of the audience terminal, or microphone audio data of the anchor terminal.

In some embodiments, the second live-streaming screen is further configured to display virtual resource data corresponding to the first request; and the one or more instructions, when loaded and executed by a processor of an electronic device, cause the electronic device to perform:

deducting, in response to an authorization success message from the audience terminal, a virtual resource indicated by the virtual resource data from a target virtual resource account, wherein the target virtual resource account is associated with an account of the audience terminal;

wherein the authorization success message indicates that the audience terminal is authorized to transfer the virtual resource.

In some embodiments, the one or more instructions further cause the electronic device to perform:

switching, in response to completing the online game teaching, a control authority of the current live-streaming game from the audience terminal to the anchor terminal.

In some embodiments, the one or more instructions further cause the electronic device to perform:

receiving and storing score data from the audience terminal, wherein the score data is configured to evaluate the online game teaching of the anchor terminal.

In some embodiments, the one or more instructions further cause the electronic device to perform:

determining ranking data of the current live-streaming game based on the score data of the current live-streaming game, wherein the ranking data indicates score rankings of anchors providing online game teaching for the current live-streaming game;

sending the ranking data of the current live-streaming game to the audience terminal, wherein the audience terminal is configured to display the ranking data of the current live-streaming game and a game type of the current live-streaming game.

According to the embodiments of the present disclosure, a method for processing game live streaming is provided. The method for processing game live streaming is applied to a game live-streaming platform. For example, the game live-streaming platform is the live-streaming server 101 in FIG. 1, and the method includes the following steps:

In S91, acquiring, in response to a first request instruction from a first client, a first game live-streaming interface by performing rendering based on a first game video stream from the first client, wherein the first game live-streaming interface is at least configured to display a current live-streaming game controlled by the first client and provide a second request control for triggering a second request instruction.

In S92, switching, in response to the second request instruction from a second client, the first game video stream to a second game video stream from the second client, and acquiring a second game live-streaming interface by performing rendering based on the second game video stream.

The present disclosure allows an audience terminal and an anchor terminal to interact with each other with respect to a current live-streaming game in a game live-streaming process, which can improve the interactivity between an anchor and an audience.

In some embodiments, the method for processing game live streaming is applied to the game live-streaming platform. A game live-streaming interface including a cloud game scene is rendered in the game live-streaming platform. The cloud game scene is a scene in which the first client and the second client interact with each other based on the current live-streaming game in the game live-streaming interface, wherein the cloud game scene includes at least one of audio data of the current live-streaming game, microphone audio data of the first client, and/or microphone audio data of the second client.

In some embodiments, before responding to the first request instruction from the first client, the method for processing game live streaming further includes:

receiving the second game video stream from the second client; and

pushing the second game video stream to the first client, and acquiring the second game live-streaming interface by performing rendering in the first client based on the second game video stream, wherein the second game live-streaming interface is at least configured to display the current live-streaming game controlled by the second client and provide a first request control for triggering the first request instruction.

In some embodiments, before acquiring the first game live-streaming interface by performing rendering based on the first game video stream from the first client, the method for processing game live streaming further includes:

displaying virtual resource data corresponding to the first request instruction in the second game live-streaming interface; and

acquiring, in response to the first client being authorized successful, the virtual resource indicated by the virtual resource data from a target virtual resource account, wherein the target virtual resource account is associated with a game account of the first client.

In some embodiments, the method for processing game live streaming further includes:

after the end of game live-streaming, acquiring score data from the first client;

determining ranking data of the current live-streaming game based on the score data; and

displaying a game type of the current live-streaming game and the ranking data.

In some embodiments, the technical solution of the present disclosure essentially, or a part contributing to the prior art, or a part or all of the technical solution may be embodied in a form of a computer program product. The computer program product is stored on a non-transitory storage medium, and includes several instructions to enable an electronic device (which may be a personal computer, a server, a network device, or the like) to execute all or some steps of the method for processing game live streaming. The foregoing non-transitory storage medium includes: a USB flash disk, a read-only memory (ROM), a random access memory (RAM), a mobile hard disk, a magnetic disk, an optical disc, or other media capable of storing program code.

All embodiments of the present disclosure can be performed separately or in combination with other embodiments and are considered to be within the scope of the present disclosure.

What is claimed is:

1. A method for processing game live streaming, comprising:
acquiring, in response to a first request from an audience terminal, a first video stream from the audience terminal, wherein the first request is configured to request an anchor terminal to perform online game teaching on a current live-streaming game; and
pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

2. The method according to claim 1, further comprising:
switching, in response to the first request, a control authority of the current live-streaming game from the anchor terminal to the audience terminal.

3. The method according to claim 1, further comprising:
acquiring, in response to a second request from the anchor terminal, a second video stream from the anchor terminal; and
pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

4. The method according to claim 3, further comprising:
switching, in response to receiving the second request, a control authority of the current live-streaming game from the audience terminal to the anchor terminal.

5. The method according to claim 1, wherein the first live-streaming screen comprises an audio part, and the audio part comprises at least one of audio data of the current live-streaming game, microphone audio data of the audience terminal, or microphone audio data of the anchor terminal.

6. The method according to claim 3, wherein the second live-streaming screen is further configured to display virtual resource data corresponding to the first request; and the method further comprises:
deducting, in response to an authorization success message from the audience terminal, a virtual resource indicated by the virtual resource data from a target virtual resource account, wherein the target virtual resource account is associated with an account of the audience terminal;
wherein the authorization success message indicates that the audience terminal is authorized to transfer the virtual resource.

7. The method according to claim 1, further comprising:
switching, in response to completing the online game teaching, a control authority of the current live-streaming game from the audience terminal to the anchor terminal.

8. The method according to claim 1, further comprising:
receiving and storing score data from the audience terminal, wherein the score data is configured to evaluate the online game teaching of the anchor terminal.

9. The method according to claim 8, further comprising:
determining ranking data of the current live-streaming game based on the score data of the current live-streaming game, wherein the ranking data indicates score rankings of anchors providing online game teaching for the current live-streaming game; and
sending the ranking data of the current live-streaming game to the audience terminal, wherein the audience terminal is configured to display the ranking data of the current live-streaming game and a game type of the current live-streaming game.

10. An electronic device, comprising:
a processor; and
a memory configured to store one or more instructions executable by the processor;
wherein the processor, when loading and executing the one or more instructions, is caused to perform:
acquiring, in response to a first request from an audience terminal, a first video stream from the audience terminal, wherein the first request is configured to request an anchor terminal to perform online game teaching on a current live-streaming game; and
pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

11. The electronic device according to claim 10, wherein the processor is further caused to perform:
switching, in response to the first request, a control authority of the current live-streaming game from the anchor terminal to the audience terminal.

12. The electronic device according to claim 10, wherein the processor is further caused to perform:
acquiring, in response to a second request from the anchor terminal, a second video stream from the anchor terminal; and
pushing the second video stream to the audience terminal, such that the audience terminal acquires a second live-streaming screen by performing screen rendering based on the second video stream, wherein the second live-streaming screen is configured to display the current live-streaming game controlled by the anchor terminal.

13. The electronic device according to claim 12, wherein the processor is further caused to perform:
switching, in response to receiving the second request, a control authority of the current live-streaming game from the audience terminal to the anchor terminal.

14. The electronic device according to claim 10, wherein the first live-streaming screen comprises an audio part, and the audio part comprises at least one of audio data of the current live-streaming game, microphone audio data of the audience terminal, or microphone audio data of the anchor terminal.

15. The electronic device according to claim 12, wherein the second live-streaming screen is further configured to display virtual resource data corresponding to the first request; and the processor is further caused to perform:
deducting, in response to an authorization success message from the audience terminal, a virtual resource indicated by the virtual resource data from a target virtual resource account, wherein the target virtual resource account is associated with an account of the audience terminal;
wherein the authorization success message indicates that the audience terminal is authorized to transfer the virtual resource.

16. The electronic device according to claim 10, wherein the processor is further caused to perform:
switching, in response to completing the online game teaching, a control authority of the current live-streaming game from the audience terminal to the anchor terminal.

17. The electronic device according to claim 10, wherein the processor is further caused to perform:
receiving and storing score data from the audience terminal, wherein the score data is configured to evaluate the online game teaching of the anchor terminal.

18. The electronic device according to claim 17, wherein the processor is further caused to perform:
determining ranking data of the current live-streaming game based on the score data of the current live-streaming game, wherein the ranking data indicates score rankings of anchors providing online game teaching for the current live-streaming game; and
sending the ranking data of the current live-streaming game to the audience terminal, wherein the audience terminal is configured to display the ranking data of the current live-streaming game and a game type of the current live-streaming game.

19. A non-transitory storage medium storing one or more instructions therein, wherein the one or more instructions, when loaded and executed by a processor of an electronic device, cause the electronic device to perform:
acquiring, in response to a first request from an audience terminal, a first video stream from the audience terminal, wherein the first request is configured to request an anchor terminal to perform online game teaching on a current live-streaming game; and
pushing the first video stream to the anchor terminal, such that the anchor terminal acquires a first live-streaming screen by performing screen rendering based on the first video stream, wherein the first live-streaming screen is configured to display the current live-streaming game controlled by the audience terminal.

20. The non-transitory storage medium according to claim 19, wherein the one or more instructions further cause the electronic device to perform:
switching, in response to the first request, a control authority of the current live-streaming game from the anchor terminal to the audience terminal.
